(19) United States
(12) Patent Application Publication
(10) Pub. No.: US 2004/0190609 A1
(43) Pub. Date: Sep. 30, 2004

(54) Moving picture coding method and apparatus

(76) Inventor: Yasuhiko Watanabe, Kanagawa (JP)

Correspondence Address: NATH & ASSOCIATES, 1030 15th STREET, 6TH FLOOR, WASHINGTON, DC, 20005, US

(21) Appl. No.: 10/483,213

(22) PCT Filed: Nov. 11, 2002
(86) PCT No.: PCT/JP02/11711

(30) Foreign Application Priority Data
Nov. 9, 2001 (JP) 2001-344163

(51) Int. Cl. H04N 7/12

(52) U.S. Cl. 375/240.03; 375/240.01; 375/240.26

(57) ABSTRACT

Packet size calculator 32 obtains coded data amount N1 storable in a single packet Comparison judging section 33 obtains the rest of coded data amount storable in the packet from the coded data amount N1 and coded data amount P already stored in the packet. The section 33 variably controls a slice length in coding section 2, corresponding to whether or not coded data amount M of a macroblock calculated in coding amount calculator 35 exceeds the rest of coded data amount storable in the packet. Since it is thus possible to perform coding with the maximum slice length storable in the packet, it is possible to complete the slice in a single packet and to decrease the number of stuffing bits.

### TECHNICAL FIELD

The present invention relates to a moving picture coding method and apparatus for performing motion compensated prediction interframe coding using the slice structure.

### BACKGROUND ART

Conventionally, moving picture coding conforming to MPEG 2 is performed on a block-by-block basis. Each block (hereinafter, referred to as a macroblock) consists of 16 pixels vertical×16 pixels horizontal. Grouped one or a plurality of macroblocks in the horizontal direction on a screen is called a slice, and MPEG 2 employs coding using the slice structure. When using the slice structure, coding is performed so as to confine within a slice predictive values of motion vectors to perform motion compensation and predictive values of quantization coefficients.

When performing coding using the slice structure, a moving picture coding apparatus adds a slice header to coded data, and transmits the data to a decoding apparatus. The decoding apparatus specifies a position of a macroblock contained in a slice from information of the slice header. Further, since predictive values of motion vector to perform motion compensation and of quantization coefficients are confined within the slice, the decoding apparatus is capable of performing decoding for each slice as long as information of sequence header and picture header is obtained. In addition, a slice consisting of 16 pixels vertical and pixels horizontal of the width of an image is referred to as a full slice.

When transmission is performed using a packet exchange scheme such as Ethernet, codes are stored in a packet that is a transmission unit of the packet exchange network to transmit an image.

However, for example, when moving pictures are encoded using a method as described in ISO/IEC JTC1/SC29/WG11 MPEG93/457 Test Model 5 Rev 2 (hereinafter referred to as TM5), it is not considered to packetize coded data. TM5 encodes an image per full-slice basis. Therefore, once an error occurs in a position corresponding to a macroblock in a full slice, it is not possible to decode images of subsequent macroblocks properly. In other words, since in the slice, motion vectors and CD components of DCT coefficients are conveyed using their differential values and thus macroblocks are dependent on each other, once an error occurs in a macroblock, the error propagates over subsequent macroblocks. Thus, an error occurring in a position corresponding to a macroblock causes erroneous decoded data of the full slice.

In order to overcome such a defect, there is a method of dividing a full slice into a plurality of slices to encode while disposing a slice header of the beginning of a slice at the beginning of a packet, instead of performing coding using a full slice as a unit of coding (Japan Laid-Open Patent Publication H12-224584).

According to this method, since making the slice shorter enables the length of macroblocks through which an error is conveyed to be shorter, it is possible to improve error resistance when an error occurs in a packet and/or a packet does not reach. However, when transmission is performed in such away that a slice length is decreased and a slice header is disposed at the beginning of a packet, it is required to dispose unnecessary stuffing bits in the packet, resulting in decreases in substantial transmission amount of image data capable of being transmitted in a single packet.

### DISCLOSURE OF INVENTION

It is an object of the present invention to provide a moving picture coding method and apparatus enabling improved error resistance without decreasing the substantial transmission amount of image data.

The object is achieved by making slice length variable using information of packet size in a transmission medium in performing moving picture coding using the slice structure. That is, when the slice length is made variable, since it is possible to perform coding with the maximum slice length within a range below the packet size, it is possible to complete a slice in a single packet and to decrease the number of stuffing bits. As a result, even when a packet is lost on a transmission path, the effect of the lost packet is not imposed on decoding of coded data in other packets, and it is possible to suppress decreases in substantial transmission amount of image data caused by stuffing bit.

### BRIEF DESCRIPTION OF DRAWINGS

FIG. 1 is a block diagram illustrating a configuration of a moving picture coding apparatus according to one embodiment of the present invention;

FIG. 2 is a diagram to explain macroblock, full slice and slice;

FIG. 3 is a diagram to explain coding of the full slice;

FIG. 4 is a flowchart illustrating coding processing of full slice in the moving picture coding apparatus of the above embodiment;

FIG. 5 is a diagram to explain processing of storing coded data in a packet in the above embodiment;

FIG. 6 is another diagram to explain processing of storing coded data in a packet in the above embodiment;

FIG. 7 is another diagram to explain processing of storing coded data in a packet in the above embodiment;

FIG. 8 is another diagram to explain processing of storing coded data in a packet in the above embodiment;

FIG. 9 is another diagram to explain processing of storing coded data in a packet in the above embodiment;

FIG. 10 is another diagram to explain processing of storing coded data in a packet in the above embodiment;

FIG. 11 is another diagram to explain processing of storing coded data in a packet in the above embodiment;

FIG. 12 is another diagram to explain processing of storing coded data in a packet in the above embodiment;

FIG. 13 is a diagram illustrating a packet size and various types of header sizes prescribed in IEEE 802.3; and

FIG. 14 is a flowchart illustrating packet size calculation in the above embodiment.

### BEST MODE FOR CARRYING OUT THE INVENTION

Processes of having reached the present invention will be described first. In the conventional moving picture coding method, coding is performed with the packet size fixed and with the sliced length fixed in a frame. Therefore, when coding is performed in such a way that a slice header is disposed at the beginning of a packet, on average, codes proportional to the product of the packet size and the number of slices in a frame are used as stuffing bits. The stuffing bits are not codes corresponding to actual image data, and therefore, decrease the image quality per average bit rate.

The inventors of the present invention noted the foregoing, found out when the slice length is controlled to be variable corresponding to the packet size, codes used as stuffing bits are decreased and it is thereby possible to increase codes usable as image data, and reached the present invention.

In other words, it is a first feature of the present invention to make slice length variable using information of packet size in a transmission medium in performing moving picture coding using the slice structure. In this way, for example, when performing coding with the maximum slice length within a range below a calculated packet size, it is possible to complete a slice in a single packet and to decrease the number of stuffing bits. As a result, even when a packet is lost on a transmission path, the effect of the lost packet is not imposed on decoding of coded data in other packets, and it is possible to suppress decreases in substantial transmission amount of image data caused by stuffing bit.

In addition to making slice length variable, it is a second feature of the present invention to adjust the number of stuffing bits so as to dispose the beginning of a slice at the beginning of a packet. Since the beginning of a slice is thus disposed at the beginning of a packet, it is possible to arrange a slice header and coded data with the slice structure corresponding to the slice header always in this order from the beginning of the packet. As a result, since a slice header and coded data with the slice structure corresponding to the slice header are completed within a packet, it is possible to provide resistance to the effect caused by a missing packet on a transmission path, and to further improve error resistance.

One embodiment of the present invention will be described specifically below with reference to accompanying drawings.

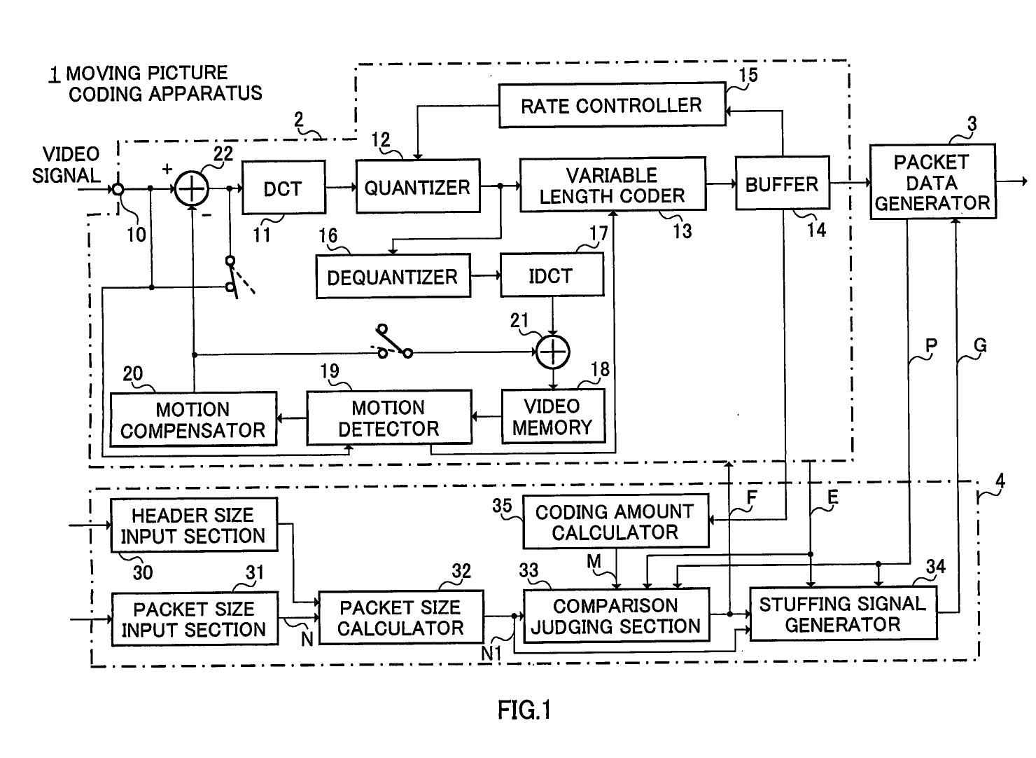

In FIG. 1, “1” denotes a moving picture coding apparatus according to this embodiment of the present invention. Moving picture coding apparatus 1 is primarily divided into coding section 2 that performs moving picture coding in compliance with MPEG 2, packet data generator 3, and code arranging section 4 that variably controls the slice length in coding section 2 corresponding to the packet size on a transmission path, while controlling packet generation in packet data generator 3.

In coding section 2, video signals are input to DCT section 11 through input terminal 10 and differential circuit 22. DCT section 11 performs matrix manipulation of DCT on the input video signals on a block-by-block basis where each block consists of 8×8 pixels, and outputs transform coefficients to quantizer 12. Quantizer 12 quantizes the input transform coefficients and outputs quantized transform coefficients. Rate controller 15 controls quantization characteristics. The quantized transform coefficients are provided to variable length coder 13, and the coder 13 performs entropy coding such as variable length coding and run length coding.

Meanwhile, dequantizer 16 performs dequantization on the coefficients and outputs decoded transform coefficients to IDCT (Inverse DCT) section 17. In this way, dequantizer 16 and IDCT section 17 perform local decoding, and decode predictive error signals with respect to P and B pictures and signal corresponding to coded image signal with respect to I picture.

Adder 21 outputs signals indicative of the sum of predictive signals with respect to P and B pictures and the signal itself with respect to I picture. Output signals from adder 21 are stored in video memory 18. An output signal (signal delayed by an amount corresponding to a frame (coded frame)) of video memory 18 is input to motion detector 19. Motion detector 19 also receives as its input the input video signal.

Based on the video signal stored in video memory 18 and the input video signal, motion detector 19 detects motion vector signal MV per macroblock basis. Motion compensator 20 performs motion compensation, based on motion vector signal MV input from motion detector 19. The predictive signal is provided to adder 22, and adder 22 calculates a difference value between the input video signal and the predictive signal. The obtained difference information is input to DCT section 11, and is encoded as described above. Buffer 14 temporarily stores coded data output from variable length coder 13 to output to packet data generator 3.

Coding section 2 practically-performs coding using the slice structure. Specifically, processing is completed within a slice including processing in motion detector 19 and motion compensator 20 and quantization in quantizer 12. It is thereby possible for a decoding side to perform decoding independently on a slice as a unit. The coding using the slice structure is a well-known technique, and the description thereof is omitted.

In code arranging section 4, the header size is input to header size input section 30, while packet size N is input to packet size input section 31. Packet size calculator 32 subtracts the header size from the packet size N, and thereby calculates a coded data amount (hereinafter referred to as actual packet size N1) storable in a packet to output to comparison judging section 33 and stuffing signal generator 34.

Comparison judging section 33 receives as its inputs, as well as the actual packet size N1, full slice end signal E from coding section 2, macroblock coded data amount M from coding amount calculator 35 and coded data amount P from packet data generator 3. Based on these pieces of information, the section 33 generates slice end signal F.

When the slice end signal F is input to coding section 2, the section 2 performs slice end processing. In other words, coding section 2 handles macroblocks before the slice end signal F is input and macroblocks after the slice end signal F is input as different slices to perform coding. In addition, specific processing in comparison judging section 33 will be described later.

Stuffing signal generator 34 receives as its inputs, as well as the actual packet size N1, coded data amount P from packet data generator 3, the slice end signal F from comparison judging section 33 and the full slice end signal E from coding section 2. Based on these pieces of information, stuffing signal generator 34 generates stuffing signal G. Specific processing in stuffing signal generator 34 will be described later.

Packet data generator 3 disposes a header at the beginning of a packet, further disposes coded data output from buffer 14 subsequent to the header, while adding stuffing bits of an amount indicated by stuffing signal G to the end portion, thereby generates packet data, and transmits the packet to a transmission path.

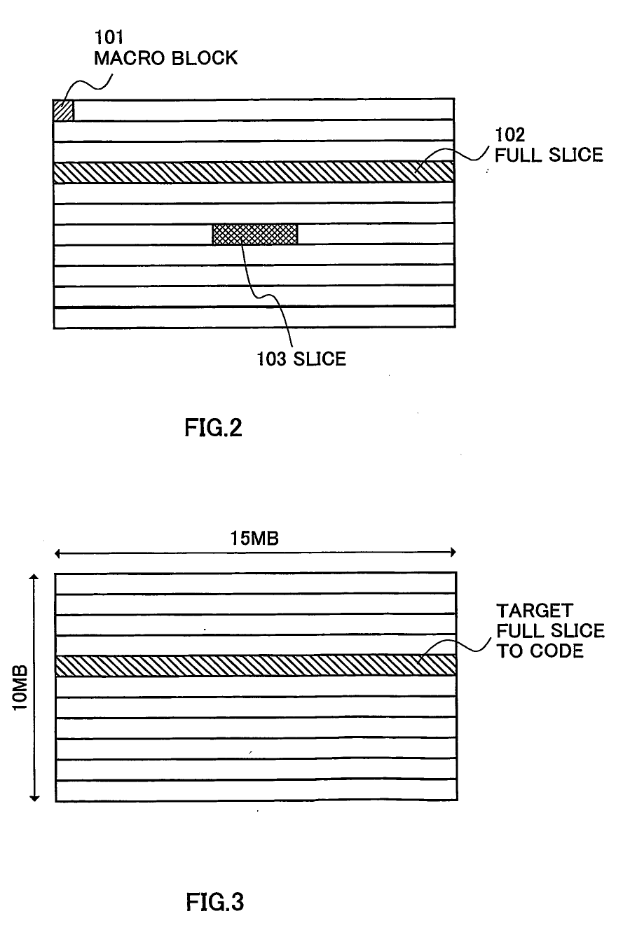

Prior to the description of the operation of moving picture coding apparatus 1, the relationship between a macroblock, full slice and slice will be described first. FIG. 2 indicates macroblock 101, full slice 102 and slice 103 composing a frame. Macroblock 101 is a pixel group consisting of 16 pixels vertical×16 pixels horizontal in a frame, and a position of a left upper pixel of macroblock 101 is selected so that remainders obtained by dividing vertically and horizontally are constant. Slice 103 consists of a number of successive macroblocks 101 in the horizontal direction. Full slice 102 consists of all macroblocks 101 in the horizontal direction.

Coding procedures using the slice structure in moving picture coding apparatus will be described below. As shown in FIG. 3, with respect to coding on a frame consisting of 15 MB (macroblocks) horizontal×10 MB vertical, as an example, a case is explained where a fifth upper full slice in the figure is coded. Herein, a frame consisting of 15 MB vertical×10 MB horizontal is used for explanation, but coding may be performed similarly on frames of another image size.

It is herein assumed that a portion for storing image coded data of a packet for transmitting an image, i.e., actual packet size is Ni bits. The actual packet size N1 varies with header size or the like for each packet, and moving picture coding apparatus 1 calculates the actual packet size N1 in packet size calculator 32.

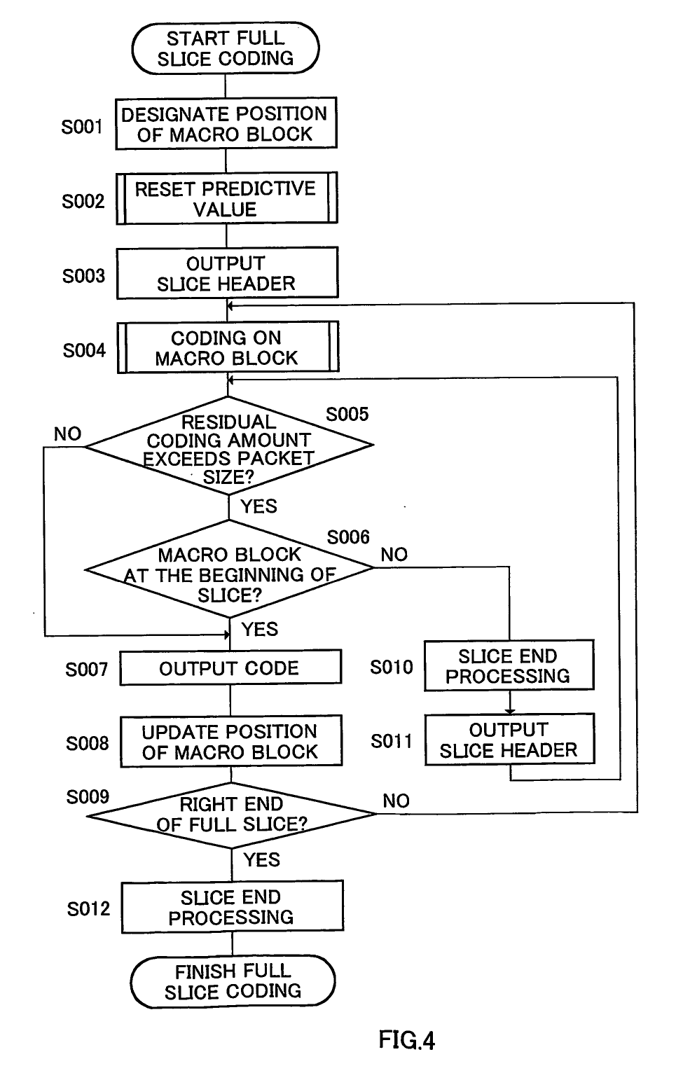

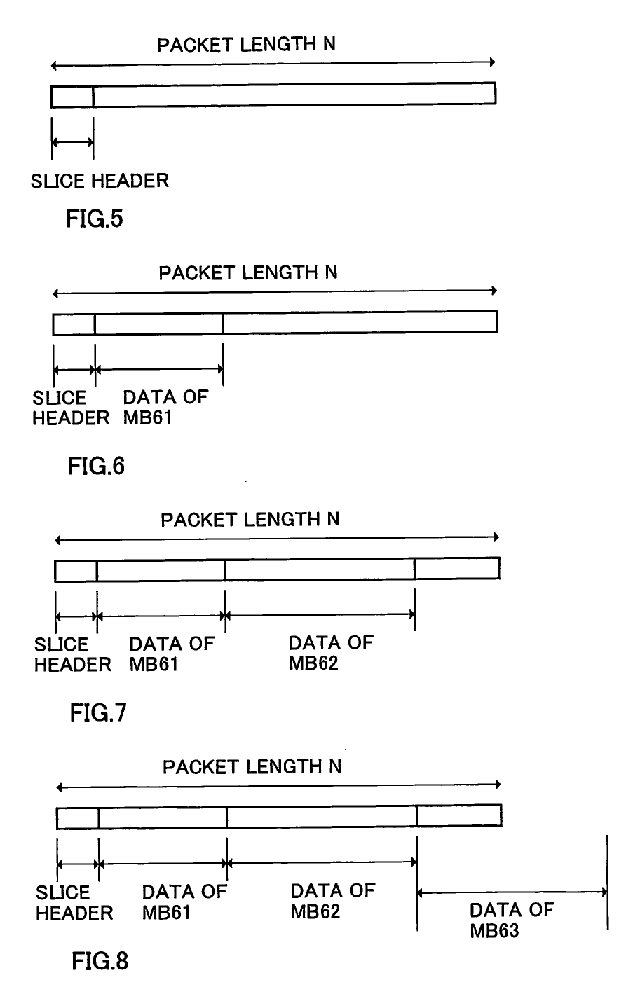

According to procedures as shown in FIG. 4, moving picture coding apparatus 1 performs coding per slice basis and generates packet data. When starting coding on a full slice, in step S001 moving picture coding apparatus 1 designates a position of a macroblock to code immediately after starting coding on the full slice. It is assumed that with respect to full slice 102 in FIG. 2, sixty-first macroblock is designated with an upper left macroblock counted as first one.

In step S002, a predictive value at the beginning of the slice is reset. This processing is required to perform coding using a slice as an independent unit of decoding, and eliminates the relation between information of macroblocks in an already coded slice and information of macroblocks to code. When coding is performed in compliance with MPEG 2, as the slice beginning processing, predictive values of a motion vector and of a DC component of DCT coefficients are reset.

In step S003, a slice header is output. In the case of coding in compliance with MPEG 2, a vertical position of the full slice is output at the beginning of the full slice. In step S004, coding is performed on the macroblock designated in step S001. This processing is to transform pixel values in the macroblock into codes using an arbitrary coding method permitted in the coding scheme, and is executed in coding section 2.

Practically, in moving picture coding apparatus 1, motion detector 19 performs block matching between a prior or past reference image and an original image of a macroblock being processed, corresponding to the picture type being coded. The detector 19 selects, as a motion vector, a position that minimizes the sum of absolute value of the difference image. Moving picture coding apparatus 1 selects either coded data subjected to intracoding or coded data using the motion vector by evaluation using the statistical amount. Further, moving picture coding apparatus 1 selects either performing DCT using the frame structure or performing DCT using the filed structure. Based on results of aforementioned selections, moving picture coding apparatus 1 performs DCT processing for each macroblock in DCT section 11, quantizes the resultant in quantizer 12, and performs variable length coding on the quantized DCT coefficients in variable length coding section 13.

Further, moving picture coding apparatus 1 calculates the coded data amount M obtained at the same time as in the above processing for each macroblock in coding amount calculator 35.

Instep S005, comparison judging section 33 compares the sum (P+M) of coded data amount P contained in a packet being generated currently and coded data amount M of the macroblock calculated in step S004 with the actual packet size N1. When comparison judging section 33 obtains a result of comparison judgment meeting P+M≦N1, i.e., when coded data of the macroblock is storable in the packet being generated currently, the processing flow proceeds to step S007.

In step S007, packet data generator 3 outputs coded data of the macroblock stored in buffer 14. In step S008, coding section 2 increments a position of a macroblock by 1 to perform processing on a next macroblock and thereby updates the position of a macroblock. Until such a result is obtained in step S009 that a macroblock is one at the right end of the full slice, a processing loop of steps S004-S005-S007-S008-S009-S004 is repeated, and thus the coding is performed repeatedly on macroblocks to store in a single packet.

Meanwhile, when in step S005 comparison judging section 33 obtains a result of comparison judgment meeting P+M>N, i.e., when coded data on the macroblock is not storable in a packet being currently processed, the processing flow proceeds to step S006. It is determined in step S006 whether or not the macroblock being coded is at the beginning of the slice, and when the macroblock is at the beginning of the slice, the processing flow proceeds to step S007, while when the macroblock is not at the beginning of the slice, the processing flow proceeds to step S010.

In moving picture coding apparatus 1 of this embodiment, since comparison judging section 33 designates an end position of a slice, coding section 2 performs coding on macroblocks sequentially as the same slice until the section 2 receives the slice end signal F from comparison judging section 33.

When it is determined that the macroblock is at the beginning of the slice in step S006, moving picture coding apparatus 1 performs processing of step S007. The processing of steps S005, S006 and S007 means that a packet is filled with data of a macroblock of the beginning of the slice, and the remaining coded data of the macroblock is output from the beginning of a subsequent packet.

In step S010, comparison judging section 33 outputs the slice end signal F to coding section 2, thus performing slice end processing. The macroblock subjected to the slice end processing is set to a macroblock at the beginning of a subsequent slice.

In step S011, packet data generator 3 outputs a slice header at the beginning of a new packet. In the case of coding in MPEG 2, this processing differs from the slice header output in step S003, and is to output a horizontal position of a macroblock as well as the slice start code.

When obtaining “yes” in step S009, in other words, when a next macroblock corresponds to the outside of the full slice, moving picture coding apparatus 1 shifts to the processing of step S012. In step S012, coding section 2 outputs the full slice end signal E to comparison judging section 33 and stuffing signal generator 34, while performing the slice end processing. Meanwhile, when obtaining “no” in step S009, in other words, when a next macroblock corresponds to the inside of the full slice, the processing flow returns to step S004.

The coded data amount of a macroblock, packet size and start of slice will be described more specifically below with reference to drawings. As an example, a fifth slice from the upper in FIG. 3 is explained. In this case, in step S001, coding is started on MB61 that is a sixty-first macroblock. As shown in FIG. 5, a slice header is stored at the beginning of the packet by the slice header output processing in step S003. Then, when coding on macroblock MB61 is finished and the sum of coded data amount M of macroblock MB61 and slice header is less than the packet size N, all the codes of macroblock MB61 can be stored in the packet as shown in FIG. 5.

Then, when coding on macroblock MB62 is finished and the sum of the slice header and coded data amounts M of macroblocks MB61 and MB62 is less than the packet size N, coded data of macroblock MB62 is output as shown in FIG. 7.

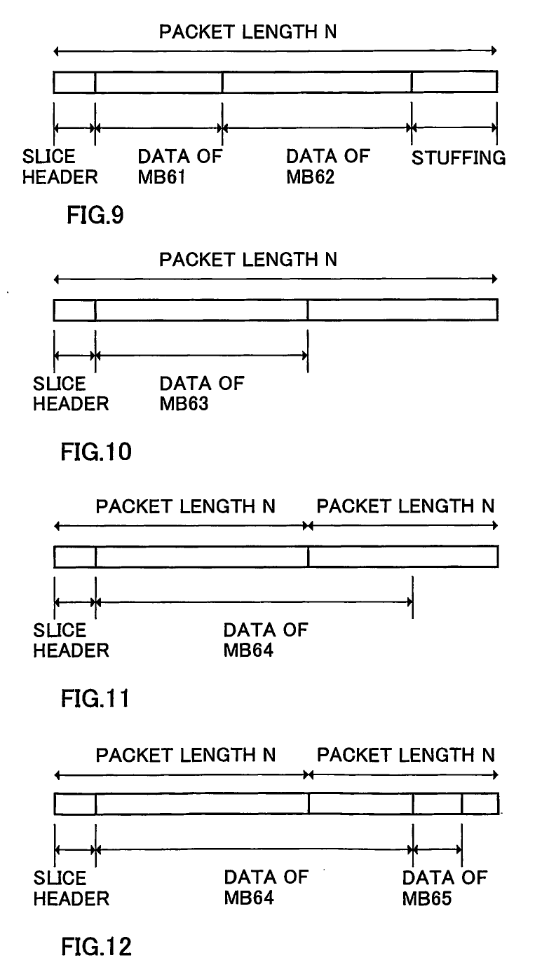

Meanwhile, when coding on macroblock MB63 is finished and as shown in FIG. 8, the sum of the slice header and coded data amounts of macroblocks MB61, MB62 and MB63 exceeds the packet size N, stuffing bits are output as data subsequent to the data of macroblock MB62 so as to fill the rest portion of the packet with the stuffing bits, as shown in FIG. 9. The amount of stuffing bits is calculated in stuffing signal generator 34 by subtracting the coded data amount P from the actual packet size N1. Coded data of macroblock MB63 is, as shown in FIG. 10, configured after the slice header disposed at the beginning of the next packet.

The case will be described below where the coded data amount of macroblock MB64 is enormous and greater than a value obtained by subtracting the slice header size from the packet size. In such a case, it may be possible to cram the data into a single packet by decreasing values of quantization coefficients or the like and performing coding on macroblock MB64 again, but in this embodiment, as shown in FIG. 11, the coded data of macroblock MB64 is stored across packets.

In addition, FIG. 11 illustrates the case where data of macroblock MB64 is stored within two packets, but it may be possible to store data across three packets or more. Further as shown in FIG. 12, when coded data of subsequent macroblock MB65 has an amount storable after the coded data of macroblock MB64, the coded data of MB65 can be stored in the same packet subsequently to the coded data of MB64.

The method of calculating the packet size in packet size calculator 32 will be described below. The case is herein explained that Ethernet (IEEE 802.3) is used as the data link layer, IP (Internet Protocol) is used as the network layer, and image data is transmitted as packets of UDP. In addition, while the case is herein explained that Ethernet (IEEE 802.3) is used as the data link layer, IP (Internet Protocol) is used as the network layer, and image data is transmitted as packets of UDP, it may be possible to similarly implement the calculation in cases of using other protocols.

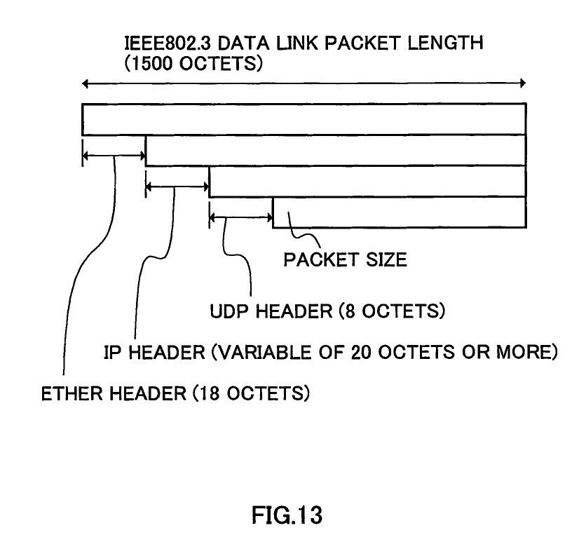

Generally, when information such as image data is packetized to transmit, as shown in FIG. 13, it is necessary to add various headers corresponding to the logical layer structure of networks. FIG. 13 illustrates the case of using networks of IEEE 802.3 as the protocol of the data link layer to transmit data. For example, in the case of performing transmission of 1500 octets in the data link layer, the header is added having 6 octets for each of transfer source and destination addresses in the data link layer, 2 octets for a type of data to transfer, and further 4 octets for CRC (Cyclic Redundancy Check) to detect data errors.

Therefore, data usable in the IP layer is 1482 (=1500−18) octets. Further, since it is necessary to transmit data of 20 octets as the header in the IP layer and CRC except the optional header, only 1462 octets of data can be transmitted at the maximum.

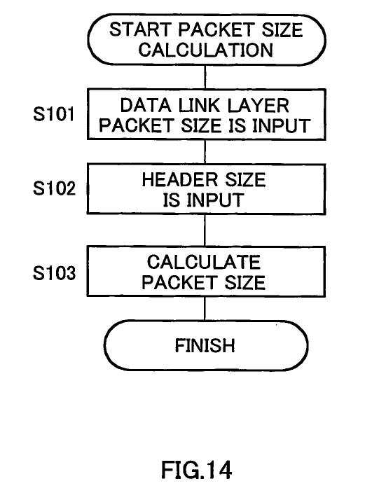

Further, when using UDP as the transport layer, since 8 octets of data is necessary for port numbers of transfer source and destination, data length and check sum, a data amount of 1454 octets becomes the packet size at the maximum when image data is in a single frame of Ethernet. In addition, depending on the data transfer method, since an optional header exists in the IP layer, the packet size is sometimes variable for each data transfer. Thus, the packet size is calculated according to procedures shown in FIG. 14 by subtracting header lengths required for protocols used in communicating data over networks from a data transfer amount in the data link layer.

In FIG. 14, instep S101, the packet size of the data link layer of Ethernet is input to packet size input section 31. In step S102, the ether header, IP header and UCP header shown in FIG. 13 are input to header size input section 30. In step S103, packet size calculator 32 subtracts the header size input to header size input section 30 or calculated from the packet size in the data link layer input to packet size input section 30, and thus calculates the actual packet size N1. The present invention provides the coding method for filling the packet size N1 with image data as much as possible.

When performing packet transmission of plurality of states, it is preferable to use the minimum packet size in each packet transfer stage as a transfer amount in the data link layer. Further, for example, when using an image transmission apparatus that is designed exclusively to image transmission and performs one-to-one connection, there is a case of eliminating the need of transmitting the transfer destination address, etc. When performing aforementioned transmission, it is preferable to calculate the actual packet size N1 with the header size considered as 0.

It is possible for general moving picture decoding apparatuses to decode coded image data packetized and output from moving picture coding apparatus 1 of this embodiment as described above. At this point, in cases except that data of a single macroblock exceeds the actual packet size (as shown in FIG. 11), with respect to data in a packet, in all the packets, a slice header and coded data of a slice corresponding to the slice header is configured always in this order starting from the beginning of a packet, and the coded data of the slice corresponding to the slice header is completed within the packet.

Therefore, when receiving packets, a moving picture decoding apparatus recognizes the slice information using the slice header, controls dequantization characteristics or the like in a dequantizer based on the slice information, and is capable of decoding all the coded data in the received packet assuredly. For example, even when a subsequent packet is lost, a further subsequent packet can be decoded irrespective of the lost packet. Also when packets are received such that data of a single macroblock exceeds the actual packet size (as illustrated in FIG. 11), it is possible to decode the data unless a packet to which the slice header is added is lost.

Thus, according to this embodiment, provided are coding section 2 that performs coding on an input image for each slice, packet size calculator 32 that calculates the packet size N1 allowed to store coded data, coding amount calculator 35 that calculates coded data amount M generated in coding section 2, and comparison judging section 33 that variably controls the length of a slice in coding section 2, based on the packet size calculated in packet size calculator 32 and coded data amount M calculated in coding amount calculator 35, whereby it is possible to achieve moving picture coding apparatus 1 capable of improving error resistance without decreasing the substantial transmission amount of image data.

That is, since it is possible to perform coding with a maximum slice length within a range below the packet size N1 by using the above configuration, it is possible to complete a slice in a single packet and to decrease the number of stuffing bits. As a result, even when a packet is lost on a transmission path, the effect of the lost packet is not imposed on decoding of coded data in other packets, and it is possible to suppress decreases in substantial transmission amount of image data caused by stuffing bit.

Further, according to the configuration of this embodiment, stuffing signal generator 34 is provided, and the number of stuffing bits is calculated such that the beginning of a slice matches with the beginning of a packet. Therefore, a slice header and coded data of the slice structure corresponding to the slice header are configured in a packet always in this order from the beginning of the packet. As a result, since a slice header and coded data with the slice structure corresponding to the header are completed within a packet, it is possible to further provide resistance to the effect caused by a missing packet on a transmission path, and to further improve the error resistance.

In addition, while this embodiment explains the case of implementing the moving picture coding method of the present invention by the configuration as illustrated in FIG. 1, the present invention is not limited to the above case. It may be possible to achieve each function as illustrated in FIG. 1 using a program.

Further, the above embodiment explains the case of applying the present invention to the moving picture coding apparatus that performs coding conforming to MPEG 2. However, the present invention is not limited to the case of performing moving picture coding conforming to MPEG 2, is applicable widely to moving picture coding apparatuses capable of independently decoding slices each composed of a plurality of blocks, and also in there cases, is capable of improving both the error resistance and effective transmission rate in the same way as in this embodiment.

The present invention is not limited to the above embodiment, and is capable of being carried into practice in various modifications thereof.

A moving picture coding method of the present invention has a coding step of performing coding on an input image using a slice structure, a step of inputting a packet size on a transmission path, a step of inputting a header size, a packet size calculating step of calculating a packet size allowed to store coded data from the packet size on the transmission path and the header size, and a generation coding amount calculating step of calculating a coded data amount generated in the coding, where the coding is performed while varying a length of a slice corresponding to the packet size allowed to store coded data and the coded data amount.

According to this method, since stuffing bits are decreased by making slice length variable, it is possible to increase the coded data amount of image data storable in a packet. For example, when the coding is performed with the maximum slice length in a range below the calculated packet size, it is possible to complete the slice in a single packet and to decrease the number of stuffing bits. As a result, even when a packet is lost on a transmission path, the effect of the lost packet is not imposed on decoding of coded data in other packets, and it is possible to suppress decreases in substantial transmission amount of image data caused by stuffing bit.

The moving picture coding method of the present invention further has a step of calculating the number of stuffing bits so as to dispose a beginning of a slice at a beginning of a packet.

According to this method, since the beginning of a slice is disposed at the beginning of a packet, a slice header and coded data of the slice structure corresponding to the slice header are configured in a packet always in this order from the beginning of the packet. As a result, since a slice header and coded data with the slice structure corresponding to the header are completed within a packet, it is possible to provide resistance to the effect caused by a missing packet on a transmission path, and to further improve the error resistance.

The moving picture coding method of the present invention further has a comparison judging step of comparing the packet size calculated in the packet size calculating step with the coded data amount calculated in the generation coding amount calculating step, and judging whether or not the coded data amount of up to some macroblock exceeds the packet size, where in the coding step, when the comparison judging step obtains a result of comparison judgment indicative of that the coded data amount of up to some macroblock exceeds the packet size, the coding is performed using macroblocks immediately before the some macroblock as a slice.

The moving picture coding method of the present invention further has a comparison judging step of comparing the packet size calculated in the packet size calculating step with the coded data amount calculated in generation coding amount calculating step, and judging whether or not the coded data amount of up to some macroblock exceeds the packet size, where when the comparison judging step obtains a result of comparison judgment indicative of that the coded data amount of up to some macroblock exceeds the packet size, coded data of macroblocks immediately before the some macroblock is stored in a single packet.

In the moving picture coding method of the present invention, when the comparison judging step obtains a result of comparison judgment indicative of that the coded data amount of up to some macroblock exceeds the packet size, coded data of the some macroblock is stored in a subsequent packet.

According to these methods, it is possible to perform coding with the slice structure while setting a maximum slice length not exceeding a packet size per macroblock basis with excellence, and to store coded data of the macroblock coded using the slice structure in a single packet with excellence.

As described above, according to the present invention, in performing the moving picture coding using the slice structure, the slice length is made variable using the information of packet size of a transmission medium, whereby it is possible to achieve the moving picture coding method and apparatus enabling improved error resistance without decreasing the substantial transmission amount of image data.

In addition to making slice length variable, the number of stuffing bits is adjusted so as to dispose the beginning of a slice at the beginning of a packet, whereby it is possible to further improve the error resistance.

This application is based on the Japanese Patent Application No. 2001-344163 filed on Nov. 9, 2001, entire content of which is expressly incorporated by reference herein.

Industrial Applicability

The present invention is suitable to be applied to the case of coding image data using the slice structure and packetizing coded data to transmit.

1. A moving picture coding method comprising:
a coding step of performing coding on an input image using a slice structure;
a step of inputting a packet size on a transmission path;
a step of inputting a header size;
a packet size calculating step of calculating a packet size allowed to store coded data from the packet size on the transmission path and the header size; and
a generation coding amount calculating step of calculating a coded data amount generated in the coding,
wherein in the coding step, the coding is performed while varying a length of a slice corresponding to the packet size allowed to store coded data and the coded data amount.

2. The moving picture coding method according to claim 1, further comprising:
a number-of-stuffing-bit calculating step of calculating the number of stuffing bits so as to dispose a beginning of the slice at a beginning of a packet.

3. The moving picture coding method according to claim 1, wherein in the generation coding amount calculating step the coded data amount is calculated on a macroblock-by-macroblock basis, and in the coding step the coding is performed while varying the length of the slice on the macroblock-by-macroblock basis corresponding to the packet size allowed to store coded data and the coded data amount on the macroblock-by-macroblock basis.

4. The moving picture coding method according to claim 1, wherein in the packet size calculating step, the packet size allowed to store coded data is a length obtained by subtracting the header size from the packet size on the transmission path.

5. The moving picture coding method according to claim 3, further comprising:
a comparison judging step of comparing the packet size calculated in the packet size calculating step with the coded data amount calculated in the generation coding amount calculating step, and judging whether or not the coded data amount of up to some macroblock exceeds the packet size,
wherein in the coding step, when the comparison judging step obtains a result of comparison judgment indicative of that the coded data amount of up to some macroblock exceeds the packet size, the coding is performed using macroblocks immediately before the some macroblock as a slice.

6. The moving picture coding method according to claim 3, further comprising:
a comparison judging step of comparing the packet size calculated in the packet size calculating step with the coded data amount calculated in the generation coding amount calculating step, and judging whether or not the coded data amount of up to some macroblock exceeds the packet size,
wherein when the comparison judging step obtains a result of comparison judgment indicative of that the coded data amount of up to some macroblock exceeds the packet size, coded data of macroblocks immediately before the some macroblock is stored in a single packet.

7. The moving picture coding method according to claim 6, wherein when the comparison judging step obtains the result of comparison judgment indicative of that the coded data amount of up to some macroblock exceeds the packet size, coded data of the some macroblock is stored in a subsequent packet.

8. The moving picture coding method according to claim 6, wherein when the comparison judging step obtains a result of comparison judgment indicative of that the coded data amount of a single macroblock exceeds the packet size, coded data of the macroblock is stored across two or more packets.

9. A moving picture coding apparatus that performs on an input image compression coding enabling decoding for each slice and packetizes coded data to transmit, the apparatus comprising:
a coding section that performs coding on an input image for each slice;
a packet size calculator that calculates a packet size allowed to store coded data;
a generation coding amount calculator that calculates a coded data amount generated in the coding section; and
a comparison judging section that variably controls a length of a slice in the coding section based on the packet size calculated in the packet size calculator and the coded data amount calculated in the generation coding amount calculating section.
